(19) United States
(12) Patent Application Publication
(10) Pub. No.: US 2021/0097983 A1
(43) Pub. Date: Apr. 1, 2021

(54) METHOD FOR MONITORING SPOKEN COMMUNICATION IN RAIL TRAFFIC AND ASSOCIATED TRAIN CONTROL SYSTEM

(71) Applicant: SIEMENS MOBILITY GMBH, Muenchen (DE)

(72) Inventor: STEPHAN GRIEBEL, WOLFENBUETTEL (DE)

(21) Appl. No.: 17/034,624

(22) Filed: Sep. 28, 2020

(30) Foreign Application Priority Data
Sep. 27, 2019 (EP) 19200176

(51) Int. Cl. G10L 15/20; G10L 15/22; G06K 9/62; H04L 9/06

(52) U.S. Cl. CPC G10L 15/20; G10L 15/22; H04L 2209/38; H04L 9/0643; G06K 9/6256

(57) ABSTRACT

A method monitors spoken communication in rail traffic. A recording of the spoken communication is created. Speech recognition is carried out on the recording in a computer-aided manner. Terms identified by the speech recognition are compared in a computer-aided manner with stored patterns for terms and in the event of impermissible deviations between the identified terms and the patterns an error message is output. Further a method for creating patterns for computer-aided speech recognition and a train control system for spoken communication are carried out.

### CROSS-REFERENCE TO RELATED APPLICATION

This application claims the priority, under 35 U.S.C. § 119, of European patent application EP 19200176, filed Sep. 27, 2019; the prior application is herewith incorporated by reference in its entirety.

### BACKGROUND OF THE INVENTION

### Field of the Invention

The invention relates to a method for monitoring spoken communication in rail traffic. The invention also relates to methods for creating patterns for computer-aided speech recognition. In addition, the invention relates to a train control system, for spoken communication. The invention lastly relates to a computer program product and a delivery apparatus for the computer program product, wherein the computer program product is equipped with program commands for carrying out the method.

It is generally known that there are line sections in the rail network which, despite progressive automation of rail traffic, are operated without the safeguard of an automatic train protection system. To protect these line sections, person-to-person communication is used. The train crew are in communication with a control center, wherein to prevent misunderstandings, a defined language must be used. In the case of Deutsche Bahn, the requirements for telephone communication are laid down, for example, in guideline RiL 436.

This specifies how operation is to be conducted using telephone requests to proceed, permissions to proceed (movement authorities) and arrival messages. The content and sequence of the communication to be used is defined in detail and must be adhered to and logged as a legal record. Consequently, pure train control operation of this kind in accordance with RiL 436 is generally carried out without technical protection, i.e. it is only the interaction of the operating personnel and precise observance of messages and permissions that is responsible for the safety of train movements.

Some extracts of the RiL 436 rules are reproduced below:

Railway sections under train control operation (German term: Zugleitbetrieb) are called train control sections, the operating points on the train control sections—stations, stops and stopping points—are called train running points. Rail traffic control is the responsibility of the dispatcher who is often at the same time traffic controller of a mainline station adjacent to the train control section. . . . To proceed over a train control section, each train must receive from the dispatcher a movement authority which is obtained in response to a request for permission to proceed. . . . The wording of the request in RiL 436 is: Does train (number) have permission to proceed to (name of train running point/train reporting point)? If all the conditions are fulfilled, the dispatcher issues a movement authority with the words: train (number) has permission to proceed to (name of train running point/train reporting point); (possibly also: meeting point with train (number). Or if not all the conditions are met: No, wait. On arrival at the train running point to which movement authority has been granted, the dispatcher must be informed of the arrival of the train by the arrival message: train (number) at (name of train running point/train reporting point). Only when the arrival message has been received is the dispatcher allowed to issue an authority to a following train to proceed to a train running point in rear. This ensures that at least one line section remains clear between two trains following one another. The movement authority and arrival message are two types of train running messages; in addition, there is the stabling message, route protection message and departure message.

### BRIEF SUMMARY OF THE INVENTION

The object of the invention is to specify a method for controlling trains and a train control system using this method whereby, notwithstanding manual train control via communication between the personnel involved, a greater degree of safety can be achieved during train operation. The object of the invention is also to specify a computer program or provision for such a computer program, wherein the computer program is capable of carrying out the method.

This object is achieved according to the invention by the subject matter as claimed in the introduction (method for monitoring) as follows: a recording is made of the spoken communication, computer-aided speech recognition is performed on the recording, terms identified using speech recognition are compared in a computer-aided manner with stored patterns for terms, and in the event of impermissible deviations between the identified terms and the patterns, an error message is output.

The recording of the communication forms the basis for subsequent speech recognition. The recording itself can be analog or preferably digital. The speech recognition provides a digital model of individual verbal elements, these being in this case terms that are used in accordance with the communication guidelines, i.e. RiL 436, for example. Terms can consist of individual words or word groups, wherein these word groups constitute fixed phrases in train communication.

Impermissible deviations are to be understood within the meaning of the invention as deviations of the terms from the stored patterns. These deviations are synonymous with the fact that, in a checking context, speech recognition does not recognize a communication as a permissible term. There is naturally a certain tolerance range within which speech recognition recognizes the commands even if the speaker, e.g. because of a dialect, produces certain deviations from the stored pattern. The fact that the terms used in the communication follow precise rules ensures that, because of the small “vocabulary” available, speech recognition provides a high degree of recognition reliability.

The basic concept of this invention is to use existing speech recognition methods, e.g. based on the so-called “hidden Markov models” which are commonly employed for speech recognition, to digitize the spoken communication in the context of train control operation in accordance with RiL 436 and, in the event of deviations from the defined procedure, to give warning feedback to the persons involved.

Although the theory of speech recognition based on hidden Markov models is some 20 years old, due to the dramatic increase in computer performance it has now become widely used in practice. Basically any other speech recognition algorithm can also be used.

The procedure described offers the following advantages. By means of inventive communication monitoring using speech recognition and automatic checking against the “approved” communication (predefined e.g. in accordance with RiL 436), safety in hitherto not automatically protected train control operation can be significantly increased.

The method according to the invention can be implemented as a new possible product as part of a digitization strategy, e.g. in the interaction between mobile terminals and local computers/databases. The operator will therefore have increased interest in this digital solution if project planning initially involves only partial digitization of the rail network. In this way, line sections which are protected using spoken communication can be incorporated into the digital environment of a partially digitized rail network.

Unless stated otherwise in the following description, the keywords “create”, “calculate”, “compute”, “determine”, “generate”, “configure”, “modify” and the like preferably relate to actions and/or processes and/or processing steps which modify and/or generate data and/or transform the data into other data. The data is present in particular as physical quantities, e.g. as electrical impulses or also as measured values. The required instructions/program commands are combined in a computer program as software. In addition, the keywords “receive” “transmit”, “read in”, “read out”, “transfer” and the like relate to the interaction of individual hardware components and/or software components via interfaces. The interfaces can be implemented in hardware, e.g. hard-wired or wireless, and/or in software, e.g. as interaction between individual program modules or program section of one or more computer programs.

In the context of the invention, “computer-aided” or “computer implemented” can be understood, for example, as an implementation of the method in which a computer or a plurality of computer carries or carry out at least one step of the method. “Computer” is to be interpreted in a broad sense, covering all electronic devices having data processing characteristics. Computers can therefore be, for example, PCs, servers, handheld computer systems, pocket PC devices, mobile phones and other communication devices which process data in a computer-aided manner, processors and other electronic devices for data processing which can preferably also be interconnected to form a network. In the context of the invention, a “storage unit” can be understood, for example, as computer-readable memory in the form of random-access memory (RAM) or a data storage device such as a hard disk or data carrier.

In the context of the invention, a “processor” can be understood as meaning, for example, a machine such as a sensor for generating measured values or an electronic circuit. A processor can be in particular a central processing unit (CPU), a microprocessor or a microcontroller, e.g. an application-specific integrated circuit or a digital signal processor, possibly combined with a storage unit for storing program commands, etc. A processor can also be, for example, an IC (integrated circuit), in particular an FPGA (field programmable gate array) or an ASIC (application-specific integrated circuit), or a DSP (digital signal processor). A processor can also be understood as a virtualized processor or a soft CPU. It can also be, for example, a programmable processor equipped with a configuration for carrying out a computer-aided process.

According to an embodiment of the invention it is provided that an error message takes place audibly or visually, particularly at a mobile terminal on a train and/or at operator control equipment in a control center.

An audible error message is particularly advantageous because train control likewise takes place audibly via spoken communication and the train driver as well as the personnel in the control center are geared to audible signal transmission (speech). An audible signal will therefore also be readily perceived when personnel are not focusing on visual output devices during the error message.

An error message can be visually displayed on visual output devices such as screens. The advantage of this is that this infrastructure is present anyway and personnel are prepared for evaluation of the emitted via these output devices. Another visual output device can be e.g. a warning lamp which is activated for this purpose. The advantage of this is that the signal is unambiguous (if personnel are properly trained) and can also be output if a screen has to be used as an output device for handling other information transmission tasks.

According to an embodiment of the invention it is provided that the train's position when the recording is created is taken into account for comparing the terms.

The position of the train can be determined e.g. by GPS. Knowledge of the position is helpful for documentation purposes. For example, it is advantageous to correlate the train's current position with the recording of the communication so that it is also possible to establish where which train control terms were used.

According to an embodiment of the invention it is provided that the position is checked against line data and/or location-dependent weather data. According to another embodiment of the invention it is provided that, for checking the position, terms are taken into account that are correlated with the line data and/or with the weather data.

Checking the position against line data, e.g. from a route map, or weather data which can be provided by a weather service, for example, makes it possible to correlate it with the spoken communication as part of train control. The advantage of this is that the context of the line and the environmental conditions (e.g. weather) can be included in the assessment as to whether an adequate term has been used during the train control process. In other words it can only be checked whether terms have been used that are permissible according to the communication standards, but also whether these terms have been used in a meaningful manner. For example, if it is known in which order the stations of a line section are served, it can be checked whether there is a train communication error on the part of the personnel involved as to which station is being approached. Another possibility is to reduce permissible maximum speeds according to weather conditions, so that, depending on the situation, the movement authority of a particular speed is interpreted as an incorrect assessment of the situation and is output as an error.

According to an embodiment of the invention it is provided that the absence of a term correlated with the line data and/or with the weather data is also interpreted as a deviation.

As a result it is also advantageously possible that a particular term is to be expected from the context of the line section being traversed, wherein the absence of this term, i.e. the fact that it is not detected, will be interpreted as indicating an error of judgment on the part of the personnel involved in train communication. This fact is advantageously indicated as an error so that personnel are made aware of it and the error can be promptly rectified before negative consequences ensue.

According to an embodiment of the invention it is provided that the recording is stored after speech recognition has been performed.

According to an embodiment of the invention it is provided that blockchain technology is used for storing the recording.

Storing the entire communication using the blockchain method provides legally clearly defined verification possibilities. This is guaranteed due to the fact that content stored using blockchain technology is protected against unauthorized modification. Blockchain technology therefore ensures the required protection against data falsification and therefore meets the stringent safety requirements of the railroad industry. This data can be used, for example, to find the causes in the event of disruptions.

Advantageously, storage in blockchain technology can be implemented particularly easily if a cloud service is used for central storage of the communication. Cloud technology advantageously enables the storage resources associated with the cloud to be used for storing the communication without separate storage capacities needing to be provided.

A “cloud” is to be understood as an environment for “cloud computing”, by which is meant an IT infrastructure that is made available via a network such as the Internet. It generally comprises storage, computing capacity or application software as a service, without these having to be installed on the local computer using the cloud. These services are provided and used exclusively through interfaces and protocols, e.g. by means of a web browser. The range of services offered as part of cloud computing encompasses the entire IT spectrum and includes, among other things, infrastructure, platforms and software.

The stated object is also alternatively achieved according to the invention by the claimed subject matter mentioned in the introduction (method for pattern creation) as follows:

terms that are required for spoken communication in train operation are identified; and

using the terms, a speech recognition program is trained by computer, wherein the terms are stored as patterns for performing computer-aided speech recognition.

The creation of patterns is necessary, as speech recognition has to compare the recording of the spoken language with the keywords to be used in accordance with the standard for train communication. The method thus inventively constitutes the first phase for preparing the application of speech recognition in which the program for speech recognition must be trained. It is therefore advantageously possible to train a speech recognition program so that it can be used for communication. The associated advantages have already been explained above and will not be re-iterated at this juncture.

According to an embodiment of the invention it is provided that machine learning is used.

The advantage of carrying out machine learning is that the process of creating patterns for speech recognition can take place in an automated manner. In particular, it is advantageously also possible, during the application of speech recognition, to correct errors which occur repeatedly because of imprecise or incorrect patterns, by retrospective training of speech recognition. Machine learning therefore enables a continuous optimization process for the application of the monitoring method according to the invention. To carry out machine learning, the computer infrastructure that is to perform the machine learning must be equipped with artificial intelligence.

In the context of this invention, artificial intelligence (hereinafter also abbreviated to Al) is to be understood in the narrower sense as computer-aided machine learning (hereinafter also abbreviated to ML). This is the statistical learning of the parameterization of algorithms, preferably for complex applications. On the basis of previously entered learning data, the system uses ML to detect patterns and conformities in the process data recorded. Using suitable algorithms, independent solutions to problems occurring can be found by ML. ML is subdivided into three fields—supervised learning, unsupervised learning and reinforcement learning, with the more specific (sub-)applications regression and classification, structure detection and prediction, data generation (sampling), and autonomous action.

For supervised learning, the system is trained by the correlation between input and associated output of known data. This depends on the availability of correct data, because if the system is trained using bad examples, it will learn incorrect correlations. For unsupervised learning, the system is likewise trained using example data, but only with input data and without correlation to a known output. It learns how to form and expand data groups, which is typical and where deviations occur. This enables applications to be described and error states to be detected. With reinforcement learning, the system learns by trial and error by proposing solutions to given problems and receiving a positive or negative assessment of this proposal via a feedback function. Depending on the reward mechanism, the AI system learns how to perform corresponding functions.

According to an embodiment of the invention it is provided that the following are trained as terms:

predefined voice commands, particularly from RiL 436; and/or designations of the trains and stops.

Training of both the keywords used in the communication and of proper names (e.g. of the names of the stations involved) advantageously ensures that phrases which contain proper names that are not defined per se in the standard, e.g. station names, can also be recognized as an entity. In particular, this also makes it advantageously possible to check the incorrect use of station names, i.e. station names which do not occur in the speech recognition “vocabulary”. This can prevent misunderstandings from arising because personnel involved in the spoken communication have made a mistake with the station name.

According to an embodiment of the invention it is provided that, for training of the terms, location information is also processed which includes the position of the train during use of the terms in question in the rail network.

This further improves the quality of the speech recognition still further and errors resulting e.g. from the names of the station being used in the wrong order (even if the name itself was pronounced correctly) can also be detected.

The above mentioned methods are interlinked. For example, the method for creation can be used not only initially to create patterns for the method for monitoring, but can also be used to correct patterns that would result in unjustified error messages. Altogether, in the application of the two methods, a distinction can be drawn between the following phases characterizing the methods.

Phase A:

In this phase, the communication between the personnel involved in train control operation is continuously recorded and converted by means of automatic speech recognition into machine usable texts (“digitized dialog”).

Phase B:

This digitized (i.e. recognized by speech recognition) dialog of all the train control personnel involved is compared, for example, with the texts and approved sequences specified in RiL 436. These may have been deposited in a storage unit (database), for example.

Phase C:

If deviations from the approved communication are detected, an audible or visual warning is given via mobile applications or a message is sent to other installations such as control centers or similar. The train crew involved is therefore alerted and can take action to avoid any operationally hazardous situations.

Phase D:

The entire digitized communication of all train control personnel involved is additionally stored in a blockchain for subsequent analysis. This is based on the proof-of-authority principle using a PKI infrastructure.

The stated object is alternatively achieved according to the invention by the subject matter as claimed in the introduction (train control system), the latter having:

at least two communication units which are designed to establish a connection with one another for transmitting a spoken communication,

a speech recognition unit which is designed to record the spoken communication and perform computer-aided speech recognition to identify terms,

an analysis unit which is designed to perform a computer-aided comparison of the terms with stored patterns for these terms, and

an output unit for identified errors.

Also claimed is a computer program product comprising program commands for carrying out said inventive method and/or exemplary embodiments thereof, wherein the method according to the invention and/or exemplary embodiments thereof can be carried out by means of the computer program product in each case.

Additionally claimed is a delivery apparatus for storing and/or providing the computer program products. The delivery apparatus is a data carrier, for example, which stores and/or provides the computer program product. Alternatively and/or additionally, the delivery apparatus is, for example, a network service, a computer system, a server system, in particular a distributed computer system, a cloud-based computer system and/or virtual computer system which preferably stores and/or provides the computer program product in the form of a data stream.

The delivery takes place, for example, as a download in the form of a program data block and/or command data block, preferably as a file, in particular a download file, or as a data stream, in particular a download data stream, of the complete computer program product. However, this delivery may also take place, for example, as a partial download which consists of a plurality of sections and in particular is downloaded via a peer-to-peer network or delivered as a data stream. For example, such a computer program product is read into a system using the delivery apparatus in the form of the data carrier and executes the program commands so that the method according to the invention is caused to be carried out on a computer or the creation device is configured such that it generates the work item according to the invention.

Further details of the invention will now be described with reference to the accompanying drawings. Identical or corresponding elements are provided with the same reference characters in each case and will only be explained again where difference arise between the individual figures.

The exemplary embodiments explained below are preferred embodiments of the invention. In these exemplary embodiments, the components described represent individual features of the invention that are to be considered independently of one another and which also further develop the invention independently of one another and are therefore also to be viewed individually or in in a combination other than that shown as part of the invention. In addition, the embodiments described can also be supplemented by other of the already described features of the invention.

Other features which are considered as characteristic for the invention are set forth in the appended claims.

Although the invention is illustrated and described herein as embodied in a method for monitoring spoken communication in rail traffic and an associated train control system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic illustration of an exemplary embodiment of a train control system according to the invention; and

FIG. 2 is an illustration of an exemplary embodiment of a method according to the invention for creating patterns and of the method for monitoring the spoken communication in the form of respective flow charts.

### DETAILED DESCRIPTION OF THE INVENTION

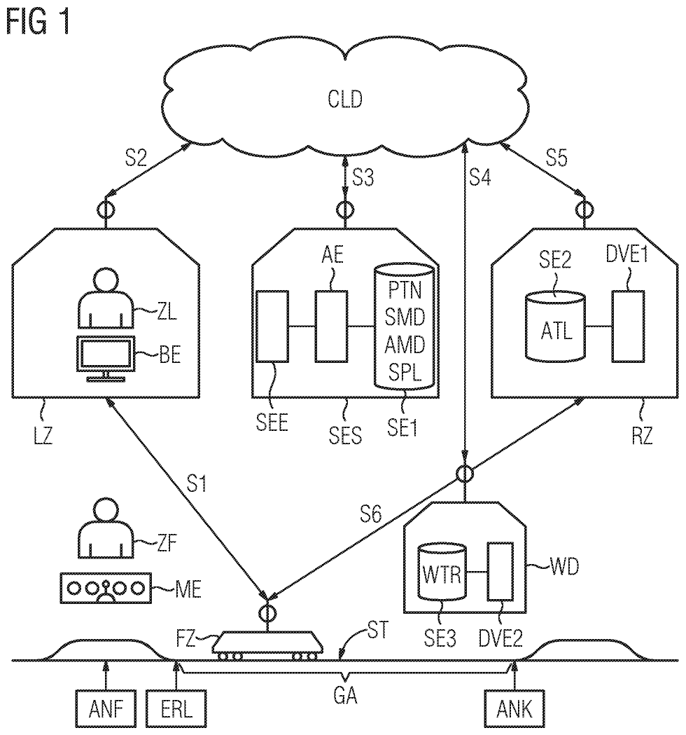

Referring now to the figures of the drawings in detail and first, particularly to FIG. 1 thereof, there is shown a line ST with a vehicle FZ in the form of a train. The vehicle FZ is traversing a single-track track section GA, wherein the vehicle FZ can communicate with a control center LZ via an interface 51.

In the control center LZ is a dispatcher ZL who can monitor rail traffic on the line ST via an operator control device BE. Via the interface S1, the dispatcher ZL communicates with a train driver ZF of the vehicle FZ who also has, in the vehicle FZ, a mobile terminal ME for operating the vehicle FZ. The vehicle FZ is controlled using verbal communication, the communication following RiL 436 guidelines (reference series RIL). Marked along the line ST in FIG. 1 are points that are characterized by the following communication events.

1. Even while the vehicle FZ is still in the double-tracked section of line ST, the train driver ZF makes a request to proceed ANF to the dispatcher ZL.

2. As the track section GA is clear, the train driver ZF is given movement authority ERL by the dispatcher ZL.

3. The vehicle FZ traverses the track section GA, wherein the train driver ZF, on leaving the track section GA, sends an arrival message ANK to the dispatcher ZL. The standardized phrases are exchanged by verbal communication via the interface S1.

According to the invention, train communication via the interface S1 is monitored by a computer center RZ, this being the responsibility of a first data processing unit DVE1. The monitoring takes place via a cloud CLD. More specifically, the sequence of steps is as follows.

The communication is transmitted from the control center LZ via the interface S1 to the cloud CLD. There a speech recognition service SES can access the data via an interface S3, wherein the speech recognition service SES contains a speech recognition unit SEE having an algorithm which is suitable for speech recognition. After speech recognition has been performed, the data is submitted by the speech recognition unit SEE for analysis using an analysis unit AE to determine whether the detected speech components coincide with the phrases normally used for train communication. For this purpose terms in the spoken language are found by the analysis unit AE which can be compared with the usual phrases according to the standard RIL. For the analysis, the analysis unit AE makes use of patterns PTN that have been stored for the different terms. Speech models SMD, acoustic models AMD and pronunciation data SPL stored in a first storage unit SE1 are also used in the analysis.

In addition, weather data WTR stored in a third storage unit SE3 can also be transferred to the cloud CLD via a second data processing unit DVE2 via an interface S4. This data comes e.g. from a weather service WD and can be used for context analysis. That is to say, there are voice commands in train communication that are issued depending on weather conditions, e.g. a speed reduction. If the associated command is absent when critical weather data is present, this can trigger an error message. An error message can be communicated directly to the vehicle FZ by the computer center RZ via an interface S6 so that it can be displayed on the mobile terminal ME.

In the computer center RZ, line data ATL of the rail network to be traversed can also be taken into account. This data is likewise transferred to the first data processing unit DVE1 and correlated with the analyzed speech data. For this purpose the computer center RZ is linked to the cloud CLD via an interface S5. Comparison against the line data ATL can be used, for example, to check the names of the stations served which are used in the standardized communication procedure. If deviations arise in that e.g. the station names are in the wrong order, an error message can be triggered in the vehicle FZ via the interface S6 in the said manner.

The interfaces S1 to S6 are shown in FIG. 1 merely by way of example. The communication between the vehicle FZ and the control center LZ as well as the computer center RZ takes place via a radio interface. This could also be handled by the cloud CLD (not shown in FIG. 1). Conversely, instead of a cloud service using the cloud CLD, there can also be direct communication of the control center LZ with the speech recognition service SES as well as with the weather service WD and the computer center RZ (not shown). In addition, these interfaces do not need to be radio interfaces, but can also be implemented via wire line interfaces (not shown).

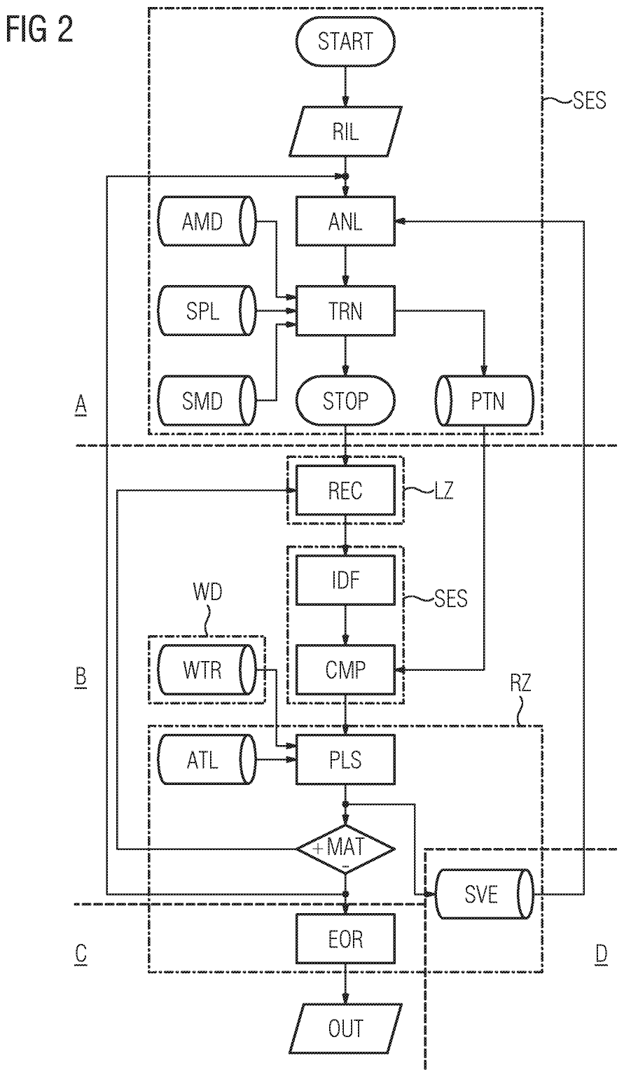

FIG. 2 shows the method for creating patterns PTN and for speech recognition in the form of a flow chart. It shows the phases A to D already mentioned above. The individual phases A to D are separated from one another by dashed lines.

In addition, the system boundaries of the units of the control center LZ, speech recognition service SES, weather service WD and computer center RZ units are indicated by dash-dotted lines in FIG. 2. This makes it clear which method steps can be carried out in which of these units in the example shown in FIG. 2.

First, training of the speech recognition system according to phase A is required. After the start, the guideline RIL, for example, is fed into the method as an input. Using available recordings of train communication which can come from a stored communication SVE, for example, an analysis step ANL can be performed in order to detect digitized terms in the phrases used. Using the acoustic models AMD, speech models SMD and pronunciation data SPL, training can then take place in a training step TRN so that patterns PTN can be created from the identified terms, which patterns can be stored for subsequent use in the recognition process. This means that stopping of the training process which basically only needs to take place once and if required if errors repeatedly occur, for example, can be repeated once more in order to improve the quality of the patterns PTN.

In the subsequent train control operation, the spoken communication between the dispatcher ZL and the train driver ZF is recorded in a recording step REC. This takes place in the control center LZ. A speech recognition step IDF is then carried out by the speech recognition service SES so that the digital terms that have been detected are compared in a subsequent comparison step CMP with the patterns PTN which are retrieved from the memory for this purpose. Then a further plausibility checking step PLS is carried out wherein the identified terms whose conformity with comparable patterns PTN has already been established can be compared against weather data WTR provided by the weather service WD, and line data ATL which is available in the computer center RZ. Here, even if the terms detected by speech recognition correspond to corresponding patterns PTN, it can be determined whether the terms identified fit the context of the train control operation in progress. For example, it can be checked whether the names of the stations are communicated in the correct order.

In a subsequent checking step MAT it is determined whether or not the plausibility-checked data conforms to train control operation. If so, the method is continued in order to check further spoken train control phrases for authenticity. Only if this is not the case, i.e. if discrepancies are found because of the train control context, or because no pattern PTN is available for the detected text, and error EOR is identified and indicated in the computer center RZ. This is forwarded to an error display OUT and can be displayed e.g. to the dispatcher ZL and/or the train driver ZF on the operator control device BE or the terminal ME respectively. In each case the communication is filed as a stored communication SVE and is therefore available for subsequent more detailed checking or analysis as part of the training step (phase A).

The following is a summary list of reference numerals and the corresponding structure used in the above description of the invention:

| | |
|---|---|
| ST | line |
| GA | track section |
| FZ | vehicle |
| ZF | train driver |
| ZL | dispatcher |
| ME | mobile terminal (e.g. control panel) |
| LZ | control center |
| BE | operator control device |
| SES | speech recognition service |
| SEE | speech recognition unit |
| AE | analysis unit |
| SE1 . . . SE3 | storage unit |
| WD | weather service |
| DVE1 . . . DVE2 | data processing unit |
| RZ | computer center |
| CLD | cloud |
| S1 . . . S6 | interface |
| ANF | request to proceed to dispatcher |
| ERL | movement authority to train driver |
| ANK | arrival message to dispatcher |
| A | phase A |
| B | phase B |
| C | phase C |
| D | phase D |
| RIL | guideline (e.g. RiL 436) |
| ANL | analysis step |
| AMD | acoustic models |
| SPL | pronunciation data |
| SMD | speech models |
| TRN | training step |
| PTN | pattern |
| REC | recording step |
| IDF | speech recognition step |
| CMP | comparison step (with patterns) |
| WTR | weather data |
| ATL | line data |
| PLS | plausibility checking step |
| MAT | checking for conformity |
| SVE | stored communication |
| EOR | error outputs |
| OUT | error display |

1. A method for monitoring spoken communication in rail traffic, which comprises the steps of:
creating a recording of the spoken communication;
carrying out speech recognition of the recording in a computer-aided manner;
comparing terms identified by the speech recognition in a computer-aided manner with stored patterns for the terms; and
outputting an error message in an event of impermissible deviations between identified terms and the stored patterns.

2. The method according to claim 1, which further comprises outputting audibly or visually the error message.

3. The method according to claim 1, which further comprises taking into account a position of a vehicle when the recording is made for comparing the terms.

4. The method according to claim 3, which further comprises checking the position against line data and/or location-dependent weather data.

5. The method according to claim 4, wherein for checking the position, the terms that are correlated with the line data and/or with the location-dependent weather data are taken into account.

6. The method according to claim 5, wherein an absence of a term correlated with the line data and/or with the location-dependent weather data is also interpreted as a deviation.

7. The method according to claim 1, which further comprises storing the recording after the speech recognition has been performed.

8. The method according to claim 7, which further comprises using blockchain technology for storing the recording.

9. The method according to claim 1, which further comprises outputting audibly or visually the error message to a mobile terminal of a vehicle and/or an operator control device of a control center.

10. A method for creating patterns for computer-aided speech recognition, which comprises the steps of:
identifying terms that are required for spoken communication in train traffic; and
training a speech recognition program using the terms in a computer-aided manner, wherein the terms are stored as patterns for carrying out the computer-aided speech recognition.

11. The method according to claim 10, wherein machine learning is applied.

12. The method according to claim 10, wherein the following are trained as the terms;
defined voice commands; and
designations of trains and stops.

13. The method according to claim 10, wherein for training the terms, location information which includes a position of a vehicle during use of the terms in question in a rail network is also processed.

14. The method according to claim 12, wherein the defined voice commands are from RiL 436.

15. A train control system for spoken communication, comprising:
at least two communication units which are configured to establish a connection between one another for transmitting a spoken communication;
a speech recognition unit configured to record the spoken communication and carry out computer-aided speech recognition to identify terms;
an analysis unit configured to carry out a comparison of the terms with stored patterns for the terms in a computer-aided manner; and
an output unit for identified errors.

16. A non-transitory medium storing computer executable instructions for performing a method for monitoring spoken communication in rail traffic, the method comprises the steps of:
creating a recording of the spoken communication;
carrying out speech recognition of the recording in a computer-aided manner;
comparing terms identified by the speech recognition in a computer-aided manner with stored patterns for the terms; and
outputting an error message in an event of impermissible deviations between identified terms and the stored patterns.
